(19) United States
(12) Patent Application Publication
(10) Pub. No.: US 2022/0159934 A1
(43) Pub. Date: May 26, 2022

(54) ANIMAL HEALTH AND SAFETY MONITORING

(71) Applicant: KYNDRYL, INC., NEW YORK, NY (US)

(72) Inventors: Christopher L. Molloy, Raleigh, NC (US); Robert S. Milligan, Erlanger, KY (US); Julie A. Schuneman, Jacksonville, FL (US); Melinda Reese Consiglio-Flynn, Ashland, MO (US)

(21) Appl. No.: 17/104,227

(22) Filed: Nov. 25, 2020

(51) Int. Cl. A01K 29/00; A01K 11/00; G06K 9/00; G06K 9/62

(52) U.S. Cl. CPC A01K 29/005; A01K 11/006; G06K 9/6256; G06K 9/00771; G06K 9/00362

(57) ABSTRACT

Computer-implemented methods, systems and computer program products leveraging cognitive learning, and machine learning algorithms to predictively identify and monitor animals within a monitoring zone in real-time and identify an occurrence of unwanted or unsafe behaviors being performed by the animals. Surveillance systems and sensors within a monitoring zone or affixed to the animals provide audio/visual data and sensor data describing activity and animals within the monitoring zone. Machine learning models are trained using audio-visual, sensor and historical data to learn to predict the identities of registered animals based on the sight or sound of the animals. Behaviors of animals that are unsafe and should be corrected can be remediated, minimized or altered using IoT devices positioned within the monitoring zone perform pre-determined actions initiated automatically in response to identification of unsafe behaviors or upon verification by users of the occurrence of the unsafe events or conditions within the monitoring zone.

### TECHNICAL FIELD

The present disclosure relates generally to the field of cognitive computing and more specifically to the use of cognitive computing for predictive health and safety monitoring in the field of animal husbandry.

### BACKGROUND

The field of data analytics can be described as the discovery, interpretation and communication of meaningful patterns in one or more data sets. The field of analytics can encompass a multidimensional use of fields including the use of mathematics, statistics, predictive modeling and machine learning techniques to find the meaningful patterns and knowledge in the collected data. Analytics can turn the collection of raw data into insight which can be applied to make smarter, better and more informed decisions based on the patterns identified by analyzing the collected sets of data.

Predictive modeling may be referred to as a process through which a future outcome or behavior can be predicted based on known results. A predictive model can learn how different data points connect with and/or influence one another in order to evaluate future trends. The two most widely used predictive models are regression and neural networks. Regression refers to linear relationships between the input and output variables, whereas neural networks are useful for handling non-linear data relationships. Predictive modeling works by collecting and processing historical data, creating a statistical model comprising a set of predictors or known features and applying one or more probabilistic techniques to predict a likely outcome using the predictive model.

### SUMMARY

Embodiments of the present disclosure relate to a computer-implemented method, an associated computer system and computer program product for monitoring animal behavior and predictively identifying animals engaging in unsafe or dangerous behavior that can be hurtful or harmful the animal's health. The computer-implemented method comprising registering, by a processor, an animal with a monitoring system, said monitoring system comprising a surveillance system observing a monitoring zone in real-time; training, by the processor, the monitoring system to recognize the animal registered with the monitoring system and further training the monitoring system to predictively identify adverse behaviors or safety events using historical data of the animal registered with the monitoring system or historical recordings of similar animals to the animal registered with the monitoring system; analyzing, by the processor, a real-time data feed comprising audio or video data collected by the monitoring system; identifying, by the processor, based on analysis of the real-time data feed, an occurrence of an adverse behavior or safety event happening in real-time; and remotely triggering, by the processor, a pre-defined action within the monitoring zone that is experienced by the animal registered with the monitoring system and is anticipated by the monitoring system to alleviate or mitigate the adverse behavior or safety event happening in real-time.

### BRIEF DESCRIPTION OF THE DRAWINGS

FIG. 1 depicts an embodiment of a block diagram of internal and external components of a data processing system, in which embodiments described herein may be implemented in accordance with the present disclosure.

FIG. 2A depicts a block diagram of an embodiment of a computing environment for predictively monitoring animal(s) for behavior, health, and safety in accordance with the present disclosure.

FIG. 2B depicts a block diagram of an alternative embodiment of a computing environment for predictively monitoring animal(s) for behavior, health, and safety in accordance with the present disclosure.

FIG. 3 depicts an embodiment of a cloud computing environment within which embodiments described herein may be implemented in accordance with the present disclosure.

FIG. 4 depicts an embodiment of abstraction model layers of a cloud computing environment in accordance with the present disclosure.

FIG. 5 depicts a flow diagram depicting an embodiment for implementing predictive monitoring of animal behavior, health and safety in accordance with the present disclosure.

FIG. 6A depicts an embodiment of a method for predictively monitoring animal(s) for behavior, health, and safety in accordance with the present disclosure.

FIG. 6B is a continuation of the method steps describing the embodiment of the method from FIG. 6A.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments chosen and described are in order to best explain the principles of the disclosure, the practical applications and to enable others of ordinary skill in the art to understand the disclosure for various embodiments with various modifications as are suited to the particular use contemplated.

Overview

Animals tend to be inquisitive by nature and often explore their environmental surroundings. As a result of this inquisitive nature and curiosity, animals (both domesticated pets and livestock) may often find themselves in situations that can be potentially unsafe or detrimental to the health and well-being of the animal. For example, pets and livestock may find themselves exploring containers that comprise human food, medications or other chemicals and substances that may be harmful to the animal if it is ingested. In other examples of animal behavior, it may be unhealthy or dangerous for animals to break free or roam away from their intended environments established by their owners (i.e. escaping from fenced enclosures). Animals that roam outside of their established safe environments can encounter and consume dangerous flora such as toxic plants, as well as pesticides and unnatural environments that might harm the animal. For example, hazards such as fuel tanks, open electrical wiring, sharp objects, and motorized vehicles.

Certain products can be used to track the whereabouts of animals that are owned and cared for by humans. For example, camera systems, invisible fence collars, proximity collars, embeddable microchips, wearable tags and health monitoring devices, all provide some mechanism for keeping track of animals. However, each of these solutions have known drawbacks and limitations when it comes to actively monitoring and protecting the health and safety of animals engaging in certain behaviors. For instance, cameras require owners to be actively viewing video feeds of the animals at the time of an incident in order to catch the animal in the act of performing the harmful or unsafe activity. Invisible fence collars only work within a statically set perimeter while proximity collars only inform the owner how close to a particular location or item the animal is positioned. The proximity collar does not tell the owner if the animal is engaging in an unwanted or undesirable activity that may be harmful to the animal. Microchips and other types of embeddable chips, may be used to identify which animals may be engaging in harmful or undesirable activities (after the fact) but do not prevent the harmful or unsafe behaviors, nor alert an animal's caregivers while the animal is engaged in the harmful activities. Moreover, animal tags may also be used for identifying animals visually from one another, but do not provide any source of electronic information that could be used to prevent an animal from engaging in a dangerous or harmful activity.

Embodiments of the present disclosure recognize the shortcomings of certain animal tracking technologies and provides for monitoring systems, methods and computer program product to actively track animals within one or more monitoring zones in real time, alert humans when animals are engaging in or are exposed to unsafe or harmful activities and provides mechanisms for remotely deterring animals from continuing to engage in the unsafe or harmful behaviors or a mechanism for mitigating and/or alleviating exposure to unsafe environments. Embodiments of the present disclosure leverage cognitive computing, machine learning and/or predictive modeling, along with one or more audio-visual surveillance systems, sensor devices, IoT devices and/or historically collected data, to identify each of the individual animals registered with the monitoring system, predict and identify adverse, unwanted, unsafe and/or potentially harmful activities by the animals or exposure of the animal to external or harmful situations, and alert and/or provide corrective actions to deter or prevent harm to the animal. Embodiments of the disclosure may include customized learning for each of the individual registered animals, in order to more accurately predict individual behaviors and patterns of the registered animals, independent of one another. Embodiments may track and store data and learned information about the individual registered animals as part of a customized learning profile describing the historical behaviors of the registered animal, predictions about each individual registered animal's behavior, along with data describing one or more characteristics of the registered animal for visually or auditorily identifying the registered animal.

Embodiments of the present disclosure can be configured to include one or more audio surveillance systems, video surveillance systems, sensor devices such as a health monitoring device affixed to the animal, motion sensors tracking animal movements within a monitored location and/or internet-of things (IoT) devices that can affect and/or change the surrounding environments of a monitored location. For example, IoT devices can include network-accessible lights, speakers, doors, barriers, sirens, etc. Embodiments of the surveillance systems, sensor devices and IoT devices, can feed data to the monitoring system, along with historically collected data that can be referenced while training or identifying unsafe behavior and safety events caused by, or affecting the animals. Embodiments of the monitoring system can use the audio data, video data, sensor data, IoT data and historical data to train the monitoring system using predictive modeling and/or machine learning to identify animals registered with the monitoring system and behavioral or safety issues that may occur. Once trained, behavior and safety events can be identified in real-time and reported to the user or admin of the monitoring system and/or the owner of the animals. In some embodiments, when a behavior or safety event is identified, one or more pre-determined action may be implemented to deter or correct for the animal's behavior automatically and/or alleviate a potentially harmful situation the animal is being exposed to. For example, through the use of flashing lights, playing a siren noise, communicating commands over an audio system, administering corrective actions to a device worn by the animal, or other behavior-modifying actions that can be administered from a remote distance. In other embodiments, the user, admin, owner, etc. connected to the monitoring system may be notified of the behavior and safety event and may additionally receive audio, visual and/or sensor data displaying evidence of the event flagged by the monitoring system, allowing for the user, admin, owner, etc. to confirm the existence of the event, and/or select one or more pre-determined actions that may be applied to deter the animals from continuing to engage in the unwanted or unsafe behaviors causing an event to be detected and/or pre-determined actions for mitigating or alleviating external threats to the animals' health or safety.

In some instances, the embodiments of the disclosure may assist with identifying causes of harm and/or treatments that may be provided to the animal after the occurrence of a behavior or safety event that might have caused harm to an animal's wellbeing. For example, an animal rummaging through a container or cabinet and ingesting medications. Embodiments of this disclosure may not only identify the animal ingesting the medications and/or alert the owner of the ensuing event in real-time, but embodiments of this disclosure may further collect evidence that may be important for administering treatments or post-event measures to ensure proper care and safety of the animal, including identifying the type of medications ingested, the amount of medications ingested. These details can be logged in one or more files which can be retrieved at a later point in time when determining whether seeking medical attention for the animal is necessary and/or for recalling the facts of the recorded event while determining the best course for proceeding to treat the animal following the recorded behavior or safety event.

Data Processing System

The present invention may be a system, a method, and/or a computer program product at any possible technical detail level of integration. The computer program product may include a computer-readable storage medium (or media) having the computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

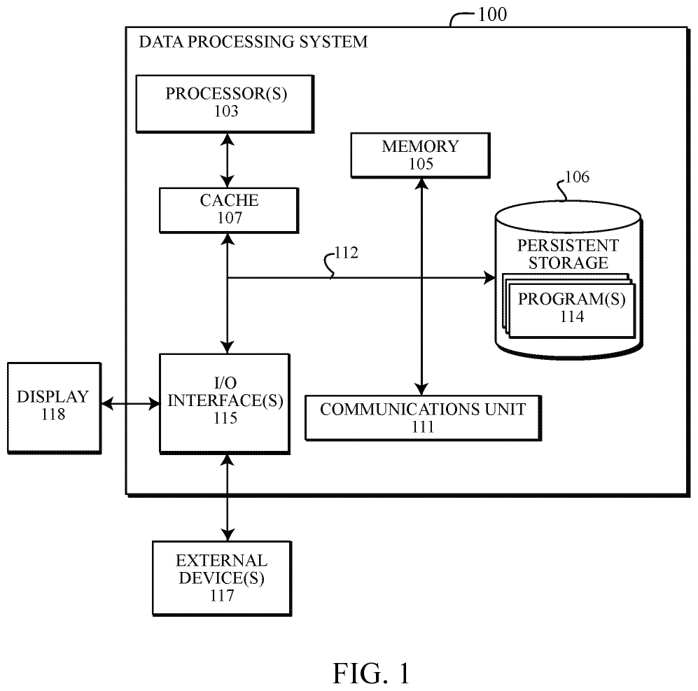

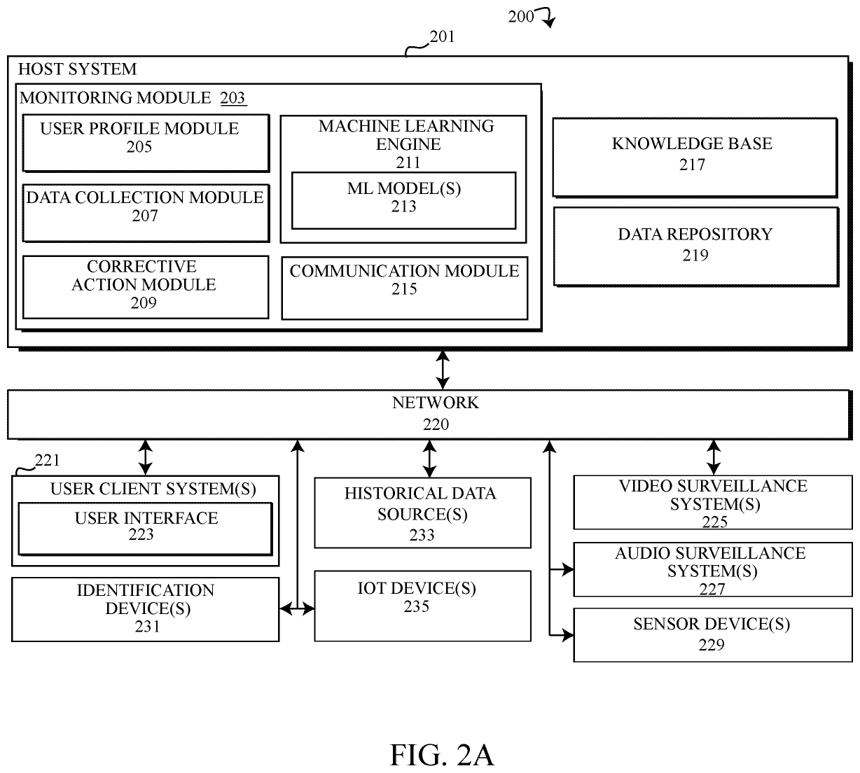

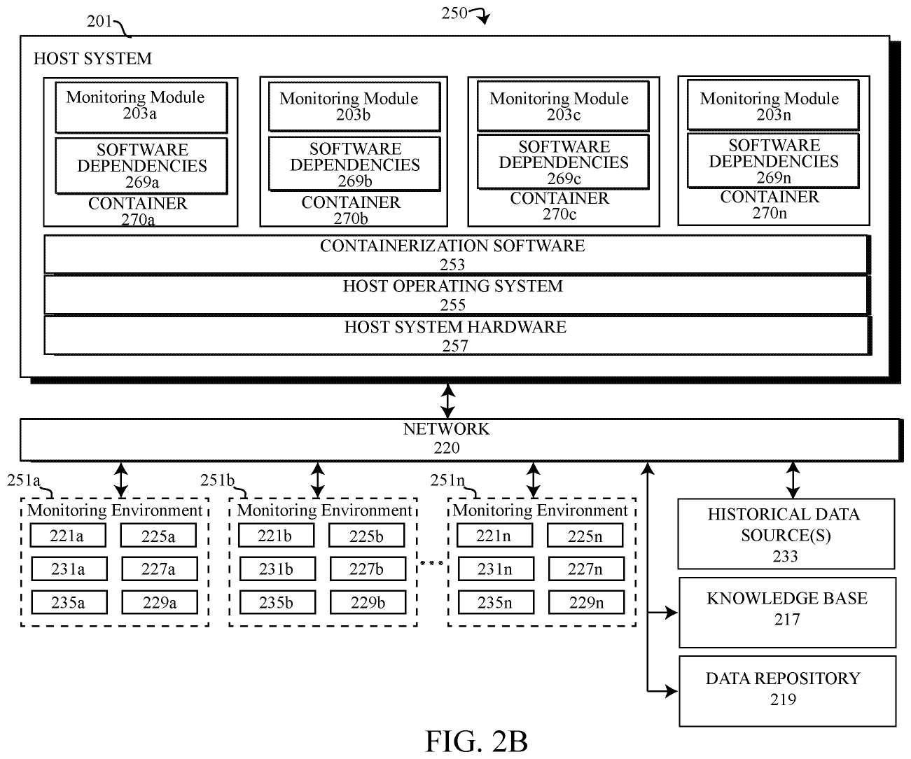

FIG. 1 illustrates a block diagram of a data processing system 100, which may be a simplified example of a computing system capable of performing one or more computing operations described herein. Data processing system 100 may be representative of the one or more computing systems or devices depicted in the computing environment 200, 250, 300 as exemplified in FIGS. 2a-5, and in accordance with the embodiments of the present disclosure described herein. It should be appreciated that FIG. 1 provides only an illustration of one implementation of a data processing system 100 and does not imply any limitations with regard to the environments in which different embodiments may be implemented. In general, the components illustrated in FIG. 1 may be representative of any electronic device capable of executing machine-readable program instructions.

While FIG. 1 shows one example of a data processing system 100, a data processing system 100 may take many different forms, both real and virtualized. For example, data processing system 100 can take the form of personal desktop computer systems, laptops, notebooks, tablets, servers, client systems, network devices, network terminals, thin clients, thick clients, kiosks, mobile communication devices (e.g., smartphones), augmented reality (AR) devices, virtual reality (VR) headsets, multiprocessor systems, microprocessor-based systems, minicomputer systems, mainframe computer systems, smart devices (i.e. smart glasses, smart watches, etc.), sensor devices 229, video surveillance systems 225, audio surveillance systems 227, identification devices 231 or Internet-of-Things (IoT) devices 235. The data processing systems 100 can operate in a networked computing environment 200, containerized computing environment 250, a distributed cloud computing environment 300, a serverless computing environment, and/or a combination of environments thereof, which can include any of the systems or devices described herein and/or additional computing devices or systems known or used by a person of ordinary skill in the art.

Data processing system 100 may include communications fabric 112, which can provide for electronic communications between one or more processor(s) 103, memory 105, persistent storage 106, cache 107, communications unit 111, and one or more input/output (I/O) interface(s) 115. Communications fabric 112 can be implemented with any architecture designed for passing data and/or controlling information between processor(s) 103, memory 105, cache 107, external devices 117, and any other hardware components within a data processing system 100. For example, communications fabric 112 can be implemented as one or more buses.

Memory 105 and persistent storage 106 may be computer-readable storage media. Embodiments of memory 105 may include random access memory (RAM) and cache 107 memory. In general, memory 105 can include any suitable volatile or non-volatile computer-readable storage media and may comprise firmware or other software programmed into the memory 105. Software program(s) 114, applications, and services described herein, may be stored in memory 105, cache 107 and/or persistent storage 106 for execution and/or access by one or more of the respective processor(s) 103 of the data processing system 100.

Persistent storage 106 may include a plurality of magnetic hard disk drives. Alternatively, or in addition to magnetic hard disk drives, persistent storage 106 can include one or more solid-state hard drives, semiconductor storage devices, read-only memories (ROM), erasable programmable read-only memories (EPROM), flash memories, or any other computer-readable storage media that is capable of storing program instructions or digital information. Embodiments of the media used by persistent storage 106 can also be removable. For example, a removable hard drive can be used for persistent storage 106. Other examples include optical and magnetic disks, thumb drives, and smart cards that are inserted into a drive for transfer onto another computer-readable storage medium that is also part of persistent storage 106.

Communications unit 111 provides for the facilitation of electronic communications between data processing systems 100. For example, between one or more computer systems or devices via a communication network. In the exemplary embodiment, communications unit 111 may include network adapters or interfaces such as a TCP/IP adapter cards, wireless Wi-Fi interface cards or antenna, 3G, 4G, or 5G cellular network interface cards or other wired or wireless communication links. Communication networks can comprise, for example, copper wires, optical fibers, wireless transmission, routers, firewalls, switches, gateway computers, edge servers and/or other network hardware which may be part of, or connect to, nodes of the communication networks' devices, systems, hosts, terminals or other network computer systems. Software and data used to practice embodiments of the present invention can be downloaded to the computer systems operating in a network environment through communications unit 111 (e.g., via the Internet, a local area network or other wide area networks). From communications unit 111, the software and the data of program(s) 114, applications or services can be loaded into persistent storage 106 or stored within memory 105 and/or cache 107.

One or more I/O interfaces 115 may allow for input and output of data with other devices that may be connected to data processing system 100. For example, I/O interface 115 can provide a connection to one or more external devices 117 such as one or more audio/visual surveillance systems 225, 227, sensor devices 229, IoT devices 235, identification devices 231, input devices such as a keyboard, computer mouse, touch screen, virtual keyboard, touchpad, pointing device, or other human interface devices. External devices 117 can also include portable computer-readable storage media such as, for example, thumb drives, portable optical or magnetic disks, and memory cards. I/O interface 115 may connect to human-readable display device 118. Display device 118 provides a mechanism to display data to a user and can be, for example, a computer monitor, screen, television, projector, display panel, movie theatre screen, etc. Display devices 118 can also be an incorporated display and may function as a touch screen as part of a built-in display of a tablet computer or mobile computing device.

System for Monitoring Animal Health and Safety

Referring to the drawings, FIGS. 2a-5 depict approaches to monitoring the health and safety of animals, that can be executed using one or more data processing systems 100 operating within a computing environment 200, 250, 300 and variations thereof. The approaches implement systems, methods and computer program products to predictively monitor animals for adverse behaviors and safety events. An adverse behavior or safety event may refer to actions or behaviors performed by either the animal(s) being monitored or external threats to the animal(s) being monitored, that could lead to undesired consequences, impacts or harmful effects on one or more of the animals' health, safety or wellbeing. Embodiments of computing environments 200, 250, 300 may include one or more data processing systems 100 interconnected via a device network 220. The data processing systems 100 connected to the device network 220 may be specialized systems or devices that may include, but are not limited to, the interconnection of one or more host system 201, client system 221, identification device 231, IoT device 235, video surveillance system 225, audio surveillance system 227 and/or sensor device 229. The data processing systems 100 exemplified in FIGS. 2a-5 may not only comprise the elements of the systems and devices depicted in the drawings of FIGS. 2a-5, but the specialized data processing systems depicted in FIGS. 2a-5 may further incorporate one or more elements of a data processing system 100 shown in FIG. 1 and described above. Although not shown in the drawings, one or more elements of the data processing system 100 may be integrated into the embodiments of host system 201, client system 221, identification device 231, IoT device 235, video surveillance system 225, audio surveillance system 227 and/or sensor device 229, including (but not limited to) the integration of one or more processor(s) 103, program(s) 114, memory 105, persistent storage 106, cache 107, communications unit 111, input/output (I/O) interface(s) 115, external device(s) 117 and display device 118.

Embodiments of the host system 201, client system 221, identification device 231, IoT device 235, video surveillance system 225, audio surveillance system 227 and sensor device 229 may be placed into communication with one another via computer network 220. Embodiments of network 220 may be constructed using wired, wireless or fiber-optic connections. Embodiments of the host system 201, client system 221, identification device 231, IoT device 235, video surveillance system 225, audio surveillance system 227 and/or sensor device 229 may connect and communicate over the network 220 via a communications unit 111, such as a network interface controller, network interface card, network transmitter/receiver or other network communication device capable of facilitating communication within network 220. In some embodiments of computing environments 200, 250, 300, one or more host system 201, client system 221, identification device 231, IoT device 235, video surveillance system 225, audio surveillance system 227 and sensor device 229 or other data processing systems 100 may represent data processing systems 100 utilizing clustered computers and components acting as a single pool of seamless resources when accessed through network 220. For example, such embodiments can be used in a data center, cloud computing network, storage area network (SAN), and network-attached storage (NAS) applications.

Embodiments of the communications unit 111 may implement specialized electronic circuitry, allowing for communication using a specific physical layer and a data link layer standard. For example, Ethernet, Fiber channel, Wi-Fi, cellular transmissions or Token Ring to transmit data between the host system 201, client system 221, identification device 231, IoT device 235, video surveillance system 225, audio surveillance system 227 and sensor device 229 connected to network 220. Communications unit 111 may further allow for a full network protocol stack, enabling communication over network 220 to groups of host system 201, client system 221, identification device 231, IoT device 235, video surveillance system 225, audio surveillance system 227 and/or sensor device 229 and other data processing systems 100 linked together through communication channels of network 220. Network 220 may facilitate communication and resource sharing among host system 201, client system 221, identification device 231, IoT device 235, video surveillance system 225, audio surveillance system 227, sensor device 229, and other data processing systems 100 connected to the network 220. Examples of network 220 may include a local area network (LAN), home area network (HAN), wide area network (WAN), backbone networks (BBN), peer to peer networks (P2P), campus networks, enterprise networks, the Internet, cloud computing networks, wireless communication networks and any other network known by a person skilled in the art.

As discussed above, one possible type of network 220 that may be employed is a cloud computing network. Cloud computing networks are a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. A cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, smart devices, IoT devices, virtual assistant hubs, etc.).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment 300 is service-oriented with a focus on statelessness, low coupling, modularity, and semantic interoperability. At the heart of cloud computing is an infrastructure that includes a network 220 of interconnected nodes 310.

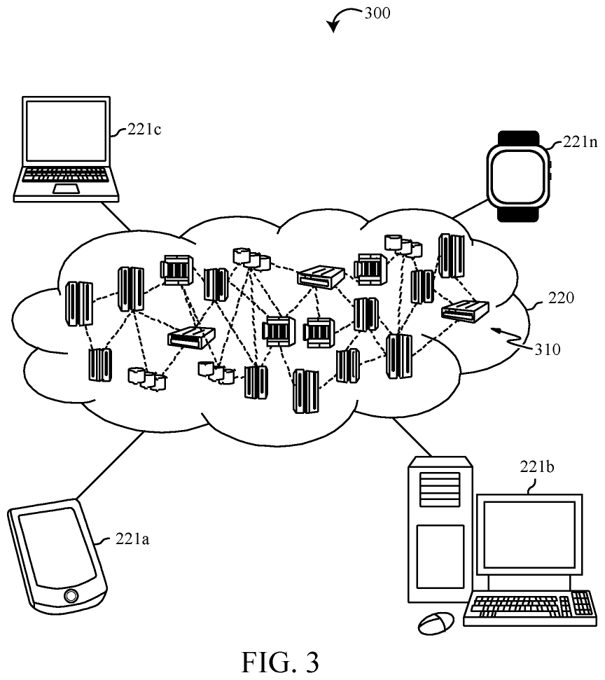

Referring to the drawings, FIG. 3 is an illustrative example of a cloud computing environment 300. As shown, cloud computing environment 300 includes one or more cloud computing nodes 310 with which client systems 221, can function as a user-controlled device operated by cloud consumers. User-controlled devices may communicate with host systems 201 of the cloud computing environment 300 through an user interface 223 accessed through one or more client systems 221 connected to the cloud network, for example via client systems 221a, 221b, 221c, 221n as illustrated in FIG. 3. Nodes 310 of the cloud computing environment 300, such as one or more host systems 201, may communicate with one another and may be grouped (not shown) physically or virtually, in one or more networks, such as Private, Community, Public, or Hybrid clouds as described hereinabove, or a combination thereof. This may allow the cloud computing environment 300 to offer infrastructure, platforms and/or software as services for which a cloud consumer does not need to maintain resources on the client system 221 or other devices connecting or communicating with the host system 201. It is understood that the types of client devices connected to the cloud computing environment 300, are intended to be illustrative only and that computing nodes 310 of the cloud computing environment 300 can communicate with any type of computerized device over any type of network and/or network addressable connection (e.g., using a web browser).

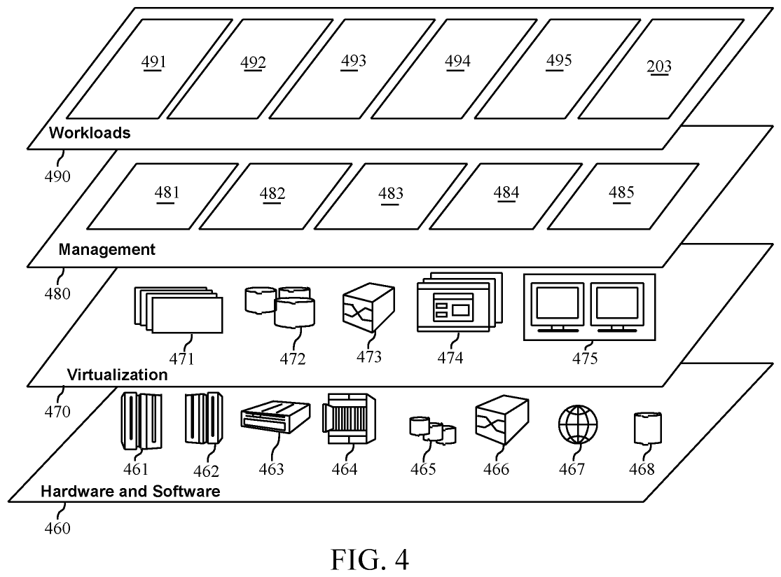

Referring now to FIG. 4, a set of functional abstraction layers provided by cloud computing environment 300 is shown. It should be understood in advance that the components, layers, and functions shown in FIG. 4 are intended to be illustrative only and embodiments of the invention are not limited thereto. As depicted, the following layers and corresponding functions are provided:

Hardware and software layer 460 includes hardware and software components. Examples of hardware components include mainframes 461; RISC (Reduced Instruction Set Computer) architecture-based servers 462; servers 463; blade servers 464; storage devices 465; and networks and networking components 466. In some embodiments, software components include network application server software 467 and database software 468.

Virtualization layer 470 provides an abstraction layer from which the following examples of virtual entities may be provided: virtual servers 471; virtual storage 472; virtual networks 473, including virtual private networks; virtual applications and operating systems 474; and virtual clients 475.

In one example, management layer 480 may provide the functions described below. Resource provisioning 481 provides dynamic procurement of computing resources and other resources that are utilized to perform tasks within the cloud computing environment 300. Metering and pricing 482 provide cost tracking as resources are utilized within the cloud computing environment 300, and billing or invoicing for consumption of these resources. In one example, these resources can include application software licenses. For instance, a license to the monitoring module 203 described in detail herein. Security provides identity verification for cloud consumers and tasks, as well as protection for data and other resources. User portal 483 provides access to the cloud computing environment 300 for consumers and system administrators. Service level management 484 provides cloud computing resource allocation and management such that required service levels are met. Service Level Agreement (SLA) planning and fulfillment 485 provide pre-arrangement for, and procurement of, cloud computing resources for which a future requirement is anticipated in accordance with an SLA.

Workloads layer 490 provides examples of functionality for which the cloud computing environment may be utilized. Examples of workloads and functions which may be provided from this layer include mapping and navigation 491, software development and lifecycle management 492, data analytics processing 493, virtual classroom education delivery 494, database interface 495, and monitoring module 203 offered by cloud computing environment 300, which can be accessed through the user interface 223 of client system 221.

Referring to the drawings, FIG. 2A depicts an embodiment of a block diagram describing a computing environment 200 capable of monitoring the behavior, health and safety of one or more animals being monitored within one or more monitoring zones established by a user via a monitoring system, program products or computer implemented method described in detail herein. As shown, the computing environment 200 may include one or more systems, components, and devices connected to the network 220, including one or more host system 201, user client system(s) 221, video surveillance system(s) 225, audio surveillance system(s) 227, sensor device(s) 229, identification device(s) 231 and/or IoT device(s) 235. Embodiments of host system 201 may be described as a data processing system 100, such as a computing system, that may provide services to the other systems and/or devices connected to network 220. In the computing environment 200 shown in FIG. 2A, host system 201 may provide predictive monitoring services providing insights, recommendations and alerts using machine learning and other cognitive computing techniques to predict the occurrence of a behavior or safety events that may adversely affect one or more monitored animal, in real-time, based on data collected from one or more surveillance systems 225, 227, sensor devices 229, identification devices 231, IoT devices 235 and/or historical data sources 233.

Embodiments of host system 201 may comprise one or more components or modules that may be tasked with implementing the functions, tasks or processes of the monitoring services being provided by the host system 201. In the example provided by FIG. 2A, the monitoring services may be provided by a monitoring module 203. The term “module” may refer to a hardware module, software module, or a module may be a combination of hardware and software resources. Embodiments of hardware-based modules may include self-contained components such as chipsets, specialized circuitry, one or more memory 105 devices and/or persistent storage 106. A software-based module may be part of a program 114, program code or linked to program code containing specifically programmed instructions loaded into a memory 105 device or persistent storage 106 device of one or more specialized data processing systems 100 operating as part of the computing environment 200. For example, the monitoring module 203 can be a program, service and/or application loaded into the memory 105, persistent storage 106 or cache 107 of the host system 201. Embodiments of the monitoring module 203 may comprise a plurality of components and/or sub modules assigned to carry out specific tasks, or functions of the monitoring module 203. As shown in the exemplary embodiment of the monitoring module 203 in FIG. 2A, the monitoring module 203 may comprise components such as a user profile module 205, data collection module 207, corrective action module 209, machine learning engine 211 and communication module 215.

Embodiments of the user profile module 205 may perform the functions and tasks of the monitoring module 203 associated with customizing user configurations and settings for a particular user, registering animals associated with the user's profile, establishing individualized profiles for each of the registered animals, setting up monitoring zones corresponding to the user profile, allocating one or more systems or devices monitoring the established monitoring zones and assigning registered animals being monitored to an established monitoring zone. For example, allocating one or more video surveillance systems 225, audio surveillance systems 227, sensor devices 229, IoT devices 235 and identification devices 231 to monitor a particular monitoring zone and animals assigned thereto. Embodiments of the user profile module 205 can create or update user profiles, customize user settings for a particular user, grant permissions that allow secondary users to access the monitoring services under the user's profile, including granting access to one or more data feeds depicting the monitoring zone in real-time, modify monitoring zones associated with user profiles, assign one or more animals to a user profile and configure one or more systems and devices for use within an established monitoring zone.

A user client system 221 may configure one or more settings and features of the monitoring module 203 by connecting to the user profile module 205 of the host system 201 via a user interface 223. From the user interface 223, first time users may register login credentials with the user profile module 205 and create a new profile which can be stored by the user profile module 205 and/or by a data repository 219 of the host system 201. In some embodiments, users accessing the user profile module 205 may create new monitoring zones associated with the user profile. A monitoring zone may refer to designated areas of physical space within the real world that can be observed and monitored by the monitoring services offered by monitoring module 203. For example, a monitoring zone may be established within a person's home, particular rooms within a home, a barn, outdoor animal pens, fenced in spaces, etc. The monitoring zones may be designated based on physical barriers, for example walls and fences (either physical or invisible) or may be virtual boundaries registered with the user profile module 205. Users may register a plurality of different monitoring zones to a user profile and may provide names, descriptions, locations, GPS coordinates, and/or the metes and bounds description of the monitoring zones being established.

Embodiments of the user profile module 205, may allow for users to associate and register one or more animals with one or more designated monitoring zones associated with the user's profile. During registration of the animals within one or more monitoring zones, users may provide images and/or videos depicting the registered animal in order to train the monitoring module 203 to visually recognize the animal. Users may further submit data describing the animal including descriptions of animal characteristics including but not limited to animal type, height, weight, size, descriptions of distinct markings or features, coloration, and identification devices 231 associated with the animal, such as tags affixed to the animal (i.e. cattle tags), microchips, RFID tags, collars or other types of identification devices 231 that may communicate and send data over network 220 to the host system 201. In some embodiments, registration of the animal may include submissions of audio recordings of the animal which may assist with training the monitoring module 203 to identify the animal being registered by sound. For example, vocal imprints and recorded sounds of the registered animal. Registered animal data, identifying characteristics, audio, video, and images used for training purposes by the monitoring module 203 to identify the animal in real-time based on data feeds of one or more surveillance systems 225, 227 (discussed in detail below) may be stored to the user profile module 205 in some embodiments. In other embodiments the identifying data submitted during registration of the animal can before stored to a data repository 219 and/or inputted as one or more records into a knowledge base 217. Moreover, in some embodiments, registration of the animal, along with images, videos, audio, animal characteristics and other data describing the animal, may be stored as part of the registered animal's profile. Individual animal profiles may be used to customize training of the monitoring module 203 to individually to recognize specific animals being registered with monitoring zones or monitoring services and maintain customize predictions about the individual habits or behaviors of the registered animals. The customized predictions and behaviors stored by the animal profiles may be based on past behaviors and historical data describing the registered animal recorded by one or more surveillance systems 225, 227, sensor devices 229, IoT devices 235, identification devices 231. Recorded data and characteristics of the registered animal may be integrated into each animal's profile. Furthermore, in some embodiments, individual animal profiles may be easily copied and transferred between host systems 201, networks 220 and computing environments 200, 250, 300, allowing for easy portability and transference of characteristics and learned behaviors for each registered animal between different monitoring zones, environments or systems performing the monitoring services.

Embodiments of the user profile module 205 may further perform the task or function of associating and/or assigning one or more devices or systems to each monitoring zone established by the user. User's may configure monitoring zones via the user interface 223 and assign one or more video surveillance systems 225, audio surveillance systems 227, sensor devices 229, and IoT devices 235 to monitor the selected monitoring zone and/or to monitor a particular animal registered to a selected monitoring zone. Embodiments of video surveillance systems 225 being assigned to a monitoring zone may include one or more video cameras, security systems, image recognition cameras, biometric camera, night vision cameras, infrared imaging devices or other recording devices capable of recording images, video within the monitoring zone. Embodiments of video surveillance systems 225 may be attached to fix locations within the monitoring zone, may be affixed to one or more animals (i.e. a collar mounted camera) and/or may be mobile, for instance by moving along a designated path such as a wire, line, track, etc. Embodiments of the video surveillance systems 225 may oscillate, pivot or rotate in a controlled manner and movement of the video surveillance systems 225 may be manually controlled remotely by a user via the user interface 223, or automatically controlled by the monitoring module 203 at a particular rate of movement designated by the user, at pre-set intervals of time and/or in a continuous back and forth motion.

Embodiments of audio surveillance systems 227 may be also be assigned to a monitoring zone and/or assigned to a particular animal registered to a monitoring zone(s). Audio surveillance systems 227 may be any device or system capable of recording sounds and/or audio data. Examples of audio surveillance systems 227 may include one or more microphones, digital recorders, and/or audio sensors. Embodiments of the audio surveillance systems 227 may be placed in fixed positions throughout an assigned monitoring zone, can move manually or automatically to different positions around the monitoring zone, or change directionality. For example, change positions or direction based on the positions and locations of the registered animals and/or may be affixed to one or more animals positioned within the monitoring zone. In some embodiments, the audio surveillance system 227 may be integrated into one or more video surveillance systems 225 to form a single surveillance system that is capable of recording and transmitting both audio and video of an assigned monitoring zone.

In some embodiments, the user profile module 205 may perform the task or function of configuring or setting up one or more sensor devices 229 being positioned within a monitoring zone and/or sensor devices 229 being affixed to one or more animals registered to a monitoring zone. Embodiments of the sensor devices 229 positioned within the monitoring zone may collect data describing the surrounding environment of the monitoring zone and may exhibit changes in the data of the sensor devices 229 in response to environmental changes of the monitoring zone. For example, sensor devices 229 may identify changes in the positions of one or more animals within the monitoring zone, and/or positions relative to known hazards, for instance using one or more motion sensors, proximity sensors, infrared sensors, optical devices, etc. In some embodiments, of the monitoring zone, certain areas may be outfitted with one or more sensors devices 229 to detect the presence of animals or an external threat to the animals, and may trigger one or more surveillance systems 225, 227 to focus on the particular area of the monitoring zone, once triggered. For example, proximity sensors can detect animals coming to close to a boundary of the monitoring zone or a known source of animal misbehavior, such as a container containing food, medicine or other substances that may be positioned within the monitoring zone and might tempt the animal to circumvent a closing or locking mechanism. Pressure sensors may be arranged within the monitoring zone and may detect similar misbehavior by animals. For instance, a pressure sensor may detect an animal climbing onto an area that the animal should not be located or may detect an animal forcing their way into a locked or off-limits location. Other examples of sensor devices 229 that may monitor the environment and/or the animal may include, but are not limited to light sensors, temperature sensors, humidity sensors, gyroscopic sensors, acceleration sensors, sound sensors, moisture sensors, image sensors, and/or magnetic sensors.

In some embodiments, sensor devices 229 comprising one or more types of sensors may be affixed to the animals registered within a monitoring zone and said sensor devices 229 may record animal movements, health parameters and/or vital statistics of the animal, indicating changes in the position and/or health of the animal over time. For example, abrupt changes in animal health parameters may be indicative of an ongoing behavior or safety event that might be causing immediate harm to an animal or may be predictive of an animal's intention to engage in commencing a behavior or safety event. For instance, changes in heart rate that are above healthy levels may indicate an animal has ingested a toxic substance and is experiencing an immediate medical emergency, whereas elevated temperature sensors may indicate an animal experiencing a fever and may therefore be sick or experiencing an infection. Embodiments of the sensor device 229 affixed to an animal may be in the form of a collar, an arm or leg band, a tag or embeddable system such as an embeddable microchip or other device.

Embodiments of the user profile module 205 may allow users to associate one or more sensor devices 229 with selected animals registered with the monitoring module 203 and may store the user's selections as part of the user's profile and/or animal profiles. For example, embodiments of sensor devices 229 affixed to an animal can track movement and direction of the animal using an accelerometer sensor to detect velocity and/or position, as well as inclination, tilt and orientation of the animal. A gyroscope may be paired with the accelerometer to provide additional degrees of motion tracking and more reliable movement measurements. An altimeter may provide measurements of the animal's height and may provide an indication that an animal has climbed to an unsafe height. Temperature sensors may be affixed to the animal and provide an indication of body temperature and may spike when an animal is unwell (i.e. running a fever). A bioimpedance sensor may measure resistance of the animal's skin to small electrical currents and may be used to measure the heart rate of the animal, while an optical sensor can also measure heart rate by measuring the rate at which blood pumps through capillaries of the animal or the pulse of the animal. Additional sensors that may be affixed to an animal and measure health parameters of the animal may include an ECG sensor measuring heart rate, a pulse oximeter measuring oxygen supply to the animal's body, and UV sensor measuring UV radiation absorption.

In some embodiments, sensor devices 229 may assist with detection of external threats that may trigger a behavior or safety event. For example, proximity sensors or motion sensors positioned along the boundaries of a monitoring zone may detect an incoming predatory animal or unauthorized human attempting to gain access from outside of a monitoring zone. For example, a predatory animal or unauthorized human being attempting to enter from outside of a fence or barrier. Upon detection of movement from the exterior of the monitoring zone's border, one or more surveillance systems 225, 227 can focus on the area of motion being detected at the point of the sensor device 229 and record the unauthorized intrusion into the monitoring zone. In another example of an external threat, smoke detectors or temperature sensors may be able to detect environmental hazards that may trigger a behavior or safety event. For instance, the outbreak of a fire in or near the monitoring zone and when the smoke detector alarm triggers and/or the temperature sensors detect a threshold level of heat, a behavior or safety event may be triggered for an automatic response and/or verification by a user or administrator of the monitoring services. For example, releasing monitoring zone doors, activating an alarm, activating a fire suppression system or sprinkler system, etc.

In some embodiments, users may register one or more IoT devices 235 with the user's profile via the user profile module 205. The registered IoT devices 235 may be positioned throughout a monitoring zone that has been created in the user's profile. An IoT device 235 may refer to any type of physical object that may be configured with a network addressable connection and may be able to transmit data and/or communicate with other IoT devices 235, data processing systems 100 and specialized computing devices over a network 220. In addition to sensor devices 229, which may be considered a subset of IoT devices 235, other types of IoT devices 235 may be positioned within monitoring zone, and may be used to control or alter the environment of the monitoring zone in some manner (i.e. automation technology). For example, the IoT devices 235 may include (but are not limited to) network-accessible lights, speakers, motorized objects such as doors, windows or containers, sirens or horns, invisible fencing, alarms, animal collars, feeding systems, fire suppression systems, sprinklers, etc. Embodiments of the IoT device 235 registered with a particular user profile and/or monitoring zone may be remotely manipulated and/or activated in response to certain animal behaviors and safety events, in order to alleviate the events and/or deter animals and/or external threats from continuing an activity associated with the event. Upon identifying a behavior or safety event that is occurring in real-time, IoT devices 235 within the monitoring zone may be activated to manually perform or automatically perform a controlled response which can be pre-determined (referred to herein as a “pre-determined response” or a “corrective action”). For example, IoT devices 235 may be activated flash lights or alter the lighting within the monitoring zone, play a pre-recorded message or command over an audio system, sound an alarm, open two-way communication with the monitoring zone (i.e. over the user client system 221), activate invisible fencing, activate a disciplinary device such as a collar, open or close-off the monitoring zone (or portions thereof), for instance by remotely opening or closing off doors or by remotely moving barriers into a new position that prevents access to locations where an event may be occurring.

Embodiments of the monitoring module 203 may comprise a data collection module 207. The data collection module 207 may perform the task or function of collecting data from one or more systems or devices positioned within a monitoring zone. For example, the data collection module 207 may collect data being transmitted to the monitoring module 203 over network 220 from one or more video surveillance systems 225, audio surveillance systems 227, sensor devices 229, IoT devices 235 and/or identification devices 231 assigned to one or more different monitoring zones. In some embodiments, the data transmitted to the data collection module 207 may be streamed to the data collection module 207 in the form of one or more data feeds, which may comprise audio data, video data, sensor data, IoT device data, identification device data, location data, GPS information and/or metadata thereof. During active monitoring of a monitoring zone, the data feeds streaming data to the data collection module 207 may be in real-time (or near real-time) and may be referred to as “real-time data feeds”. The data collected from real-time data feeds may be accurately reflecting and describing one or more conditions of the animals and the environments of the monitoring zones as the physical space of the monitoring zones change in real time.

Embodiments of the data collection module 207 may process, format and/or store the collected data and metadata to one or more onboard storage devices of the data collection module 207 and/or a data repository 219. The collected data received by the data collection module 207 may be shared or made accessible to other modules and engines of the monitoring module 203. For example, the machine learning engine 211 and/or communication module 215 may access the collected data sets stored by the data collection module 207. In some embodiments, the data collection module 207 may directly share or transmit the collected data between one or more additional modules, components and/or engines of the monitoring module 203, allowing for further processing and analysis of the collected data. In the exemplary embodiment, the data feeds received by the data collection module 207 may be stored by the data collection module 207 and transmitted to the machine learning engine 211 for additional analysis of the collected data in order to train the monitoring module 203 to learn how to identify specific registered animals, predictively identify occurrences of one or more behavior or safety events in real-time, and/or generate or update machine learning (ML) models 213 to improve predictions of such identified behavior or safety events.

In some embodiments, the data collection module 207 may access and retrieve historical data from one or more historical data sources 233. Embodiments of the historical data source 233 may be collected by the data collection module 207 and may be used by the machine learning engine 211 in order to train one or more machine learning models 213 to predict and identify behavior or safety events using past documented audio and video recordings of animals and/or external threats that may occur to the animals. For example, the data collection module 207 may access archives of videos depicting registered or predatory animals engaging in behaviors that may be harmful or compromising the registered animal's safety in order to predictively identify similar behaviors and scenarios in real-time as they may occur within a monitoring zone. Embodiments of the historical data may be a historical collection of audio, video and images of one or more registered animals currently being monitored, which may be useful for predicting future behaviors of the registered animal, if the registered animal repeats past behaviors and events. In some embodiments, the audio, video and images of the historical data may be depictions of similar animals to those animals being monitored within a monitoring zone. For example, historical data of a video depicting horses escaping from a horse corral may provide training data for teaching the monitoring module 203 to predictively identify when registered horses being monitored, may be engaged in similar patterns of behavior to the horses in the historical video and thus may indicate a behavior or safety event wherein the monitored horses may be attempting to escape from a horse corral.

In some embodiments, data feeds from the one or more surveillance systems 225, 227, sensor devices 229, IoT devices 235 and identification devices 231 may be collected by the data collection module 207 and may be archived or stored to one or more historical data sources 233. The collected data may be retrieved at a later point in time for future training by the machine learning engine 211 to update one or more machine learning models 213. In other embodiments, the monitoring services of host system 201 may provide monitoring services to collections of users, each maintaining and establishing separate monitoring zones that may each be equipped with its own set of video surveillance systems 225, audio surveillance systems 227, sensor devices 229, IoT devices 235 and identification devices 231. The data feeds from different monitoring zones or different user profiles, may deliver collections of data from each group of monitoring devices and systems to the host system 201, whereby, the monitoring module 203 can improve identification of behavior and safety events for all users of the monitoring module 203. For example, by using the collected data from different groups of monitoring zones operated by a one or more users, comprised of a set of registered animals, to predict behavior and safety events occurring in other monitoring zones operated by one or more different users. For instance, data feeds collected within the monitoring zone associated with a first user profile can be used to train the monitoring module 203 to predictively identify similar behavior or safety events that may occur within a second monitoring zone associated with a second user profile.

Machine learning engine 211 may perform functions or tasks of the monitoring module 203 directed toward creating one or more machine learning models 213 for predicting the occurrence of a behavior or safety events within a monitoring zone using one or more data feeds from existing monitoring zones and/or historical data sources 233 as well as train the machine learning engine 211 to identify a registered animal partaking in the behavior or safety events occurring in real-time. The machine learning engine 211 analyzes collected data sets of data feeds in real-time and can predict, with a particular level of confidence, when data sets received by the data collection module 207, may indicate a behavior or safety event, which animal(s) are part of the behavior and safety event and draw conclusions deciding when to alert a user via a user client system 221 and/or the recommended implementation of one or more pre-determined action in order to deter animals from commencing a particular behavior and/or to alleviate harm that may occur to an animal as a result of the behavior or safety event.

Embodiments of the machine learning engine 211 may use cognitive computing and/or machine learning techniques to identify patterns in the data collected by the data collection module 207 with minimal intervention by a human user and/or administrator. Embodiments of the machine learning engine 211 may use training methods such as supervised learning, unsupervised learning and/or semi-supervised learning techniques to analyze, understand and draw conclusions about the identities of registered animals based on collected data sets or historical data sets, as well as the identification of behavior or safety events. Moreover, in some embodiments, the machine learning engine 211 may also incorporate techniques of data mining, deep learning models, neural networking and data clustering to supplement and/or replace the machine learning techniques.

Supervised learning is a type of machine learning that may use one or more computer algorithms to train the machine learning engine 211 using labelled examples during a training phase. The term “labelled example” may refer to the fact that during the training phase, there are desired inputs that will produce a known desired output by the machine learning engine 211. For example, using images, video or audio of a registered animal or a particular type of behavior or safety event, in order to teach the machine learning engine 211 to be able to correctly identify said registered animal or the particular type of behavior or safety event described by the training data. The algorithm of the machine learning engine 211 may be trained by receiving a set of inputs along with the corresponding correct outputs. To employ supervised learning, the machine learning engine 211 may store a labelled dataset for learning, a dataset for testing and a final dataset from which the machine learning engine 211 may use for identifying a particular registered animal and/or a particular behavior or safety event. During the training phase, the machine learning engine 211 may learn the correct outputs by analyzing and describing well known data and information, that may be stored by the host system 201. For example, collected datasets from data feeds and/or historical data sets from historical data sources 233, which may be stored as part of the data collection module 207, part of a separate data repository 219 stored by host system 201 or a network-accessible data repository (as shown in FIG. 2B). The algorithm(s) of the machine learning engine 211 may learn by comparing the actual output with the correct outputs in order to find errors. The machine learning engine 211 may modify the machine learning models 213 of data according to the correct outputs to refine decision making, improving the accuracy of the automated decision making of the machine learning engine 211 to provide the correct inputs. Examples of data modeling may include classification, regression, prediction and gradient boosting.

Under a supervised learning technique, the machine learning engine 211 may be trained using historical data from one or more historical data sources 233 or previous data feeds collected from one or more monitoring zones, to make predictions about identities of particular registered animals, behaviors or safety events based on similar or the same data patterns as the data being used to train the machine learning models 213. Embodiments of the machine learning engine 211 may be continuously trained using updated historical data and as data feeds from monitoring zones continue to be collected. In some embodiments, the machine learning models 213 used for identifying registered animals or identifying behavior and safety events may be based on the level of confidence exhibited by the machine learning models 213 to correctly identify registered animals or behavior and safety event using historical data feeds and datasets collected by the data collection module 207. Embodiments of the machine learning models 213 and/or the machine learning engine 211 may update a knowledge base 217 when a level of confidence in predicting registered animal identity or an occurrence of a behavior or safety event reaches above a particular threshold set by the machine learning engine 211, host system 201 and/or administrator of host system 201. For example, a confidence level of greater than 70%, greater than 85%, greater than 90%, greater than 95%, greater than 99%, etc. Additionally, user feedback and annotations to the collected data and metadata outputted by the machine learning engine 211 may modify and improve the machine learning model's 213 ability to accurately predict an identity of a registered animal or event based on individual user feedback and annotations, and/or the collective feedback and annotations from a plurality of users of the monitoring services of monitoring module 203.

Unsupervised learning techniques may also be used by the machine learning engine 211 when there may be a lack of historical data that may be available to teach the machine learning engine 211 using labelled examples of behavior and safety events and/or registered animals. Machine learning that is unsupervised may not be “told” the right answer the way supervised learning algorithms do. Instead, during unsupervised learning, the algorithm may explore the collected datasets from the data feeds of the data collection module 207 along with user annotations and feedback data to find the patterns and commonalities among the datasets being explored, including commonalities among audio data, video data, image data, sensor data, IoT data and identification device data. Examples of unsupervised machine learning may include self-organizing maps, nearest-neighbor mapping, k-means clustering, and singular value decomposition.

Embodiments of machine learning engine 211 may also incorporate semi-supervised learning techniques in some situations. Semi-supervised learning may be used for the same applications as supervised learning. However, instead of using entirely labelled training examples of data during the training phase, there may be a mix of labelled and unlabeled examples during the training phase. For example, there may be a small or limited amount of labelled data being used as examples (i.e., a limited number of labelled historical data from historical data sources 233 or labelled datasets collected from previous data feeds acquired from a monitoring zone) alongside a larger amount of unlabeled data that may be presented to machine learning engine 211 during the training phase. Suitable types of machine learning techniques that may use semi-supervised learning may include classification, regression and prediction models.

Some embodiments of the computing environments 200, 250, 300 may comprise a knowledge base 217. Embodiments of the knowledge base 217 may be a human-readable and/or machine-readable resource for disseminating and optimizing information collection, organization and retrieval for a computing environment 200, 250, 300. The knowledge base 217 may draw upon the knowledge of humans and artificial intelligence, that has been inputted into the knowledge base 217 in a machine-readable form. For example, inputs from the real time data feed in the form of video data, audio data, sensor data, location data, health data, behavioral data, image data, IoT device data etc. Embodiments of the knowledge base 217 may be structured as a database and may be used to find solutions to current and future problems by using the data extracted from the data feeds that is being inputted into the knowledge base 217 in order to automate the decisions, responses and actions performed within the monitoring zones. In particular, in response to identifying one or more behavior or safety event taking place within said monitoring zone.

Embodiments of the knowledge base 217 may not be simply a static collection of information. Rather, the knowledge base 217 may be a dynamic resource having the cognitive capacity for self-learning, using one or more data modeling techniques and/or by working in conjunction with the machine learning engine 211 to improve the identification of animals within a monitoring zone, the identification of a behavior or safety event, making recommendations for a particular action to alleviate the behavior or safety event and/or measures for minimizing a risk of harm following a conclusion of a behavior or safety event. Embodiments of the knowledge base 217 may apply problem-solving logic and use one or more problem-solving methods to provide a justification for conclusions reached by the knowledge base 217 when implementing one or more recommendation or pre-determined action(s) within a monitoring zone.

Exemplary embodiments of knowledge base 217 may be a machine-readable knowledge base 217 that may receive, and store data extracted from one or more data feeds collected by the data collection module 207 and inputted into the knowledge base 217, along with any user feedback, or manually entered user adjustments, settings or parameters which may be stored as part of the knowledge base's knowledge corpus. A knowledge corpus may refer collections and/or the fragments of knowledge inputted into the knowledge base 217. Embodiments of the knowledge corpuses can be independent and uncoordinated from one another. For example, different data feeds collected from a plurality of separate and independent monitoring zones, whereas the knowledge base 217 may be compiling all of the knowledge corpuses, and may have an intentional ontological design for organizing, storing, retrieving and recalling the collection of knowledge provided by each knowledge corpus. The historical compilation of datasets from one or more data feed along with user feedback can be applied to making future predictions about the identities of registered animals and the occurrence of a behavior or safety event (which may be occurring in real-time). Embodiments of the knowledge base 217 may perform automated deductive reasoning, utilize machine learning of the machine learning engine 211 or a combination of processes thereof to monitor monitoring zones and recommend the application of pre-determined actions in response to animal behavior, which may have adverse consequences or may be unsafe if allowed to proceed uninterrupted.

Embodiments of a knowledge base 217 may comprise a plurality of components to operate and make decisions directed toward monitoring the animals within a monitoring zone and responding to the occurrence of an identified behavior or safety event. Embodiments of the knowledge base 217 may include components (not shown) such as a facts database, rules engine, a reasoning engine, a justification mechanism, and a knowledge acquisition mechanism. The facts database may contain the knowledge base's current fact pattern of a particular situation, which may comprise data describing a set of observations based on a continuous data feed collected by the data collection module 207 and/or user input or feedback.

Embodiments of the rules engine of knowledge base 217 may be a set of universally applicable rules that may be created based on the experience and knowledge of the practices of experts, developers, programmers and/or contributors to knowledge corpuses of the knowledge base 217. The rules created by the rules engine may be generally articulated in the form of if-then statements or in a format that may be converted to an if-then statement. The rules of knowledge base 217 may be fixed in such a manner that the rules may be relevant to all or nearly all situations covered by the knowledge base 217. While not all rules may be applicable to every situation being analyzed by the knowledge base 217, where a rule is applicable, the rule may be universally applicable.

Embodiments of the reasoning engine of knowledge base 217 may provide a machine-based line of reasoning for solving problems. For example using learned responses from the machine learning engine 211 to provide the best solution for predictively monitoring a monitoring zone for animal behavior or safety that may be harmful or dangerous to a registered animal and responding appropriately by notifying a user of such an ongoing event and/or implementing one or more pre-determined actions to alleviate the event and/or limit potential harm that may be caused by allowing the identified event to continue. The reasoning engine may process the facts in the fact database and the rules of the knowledge base 217. In some embodiments of the knowledge base 217, the reasoning engine may also include an inference engine which may take existing information stored by the knowledge base 217 and the fact database, then use both sets of information to reach one or more conclusions and/or implement an action within the monitoring zone. Embodiments of the inference engine may derive new facts from the existing facts of the facts database using rules and principles of logic.

Embodiments of the justification mechanism of the knowledge base 217 may explain and/or justify how a conclusion by knowledge base 217 was reached. The justification mechanism may describe the facts and rules that were used to reach the conclusion. Embodiments of the justification mechanism may be the result of processing the facts of a current situation occurring within a monitoring zone, in accordance with the record entries of the knowledge base 217, the reasoning engine, the rules and the inferences drawn by the knowledge base 217. The knowledge acquisition mechanism of the knowledge base 217 may be performed by manual creation of the rules, a machine-based process for generating rules or a combination thereof.

In some embodiments, the knowledge base 217 may include an analytics engine which may incorporate one or more machine learning techniques of the machine learning engine 211, either in conjunction with or as part of the knowledge base 217, to arrive at one or more a determination about the existence of a behavior or safety event, the registered animals involved with the behavior and safety event, and one or more actions to take in response to the behavior or safety event. The machine learning, whether by the analytics engine or the machine learning engine 211, may automate analytical model building, allowing for monitoring module 203 to learn from the collected data feeds inputted and analyzed by the analytics engine or machine learning engine 211, including past instances of historical data, in order to justify patterns and make decisions about future responses to predicted behavior or safety events.

Embodiments of the monitoring module 203 may further comprise a communication module 215. The communication module 215 may perform functions and tasks of the monitoring module 203 associated with creating and transmitting alerts, reports, notifications, recommendations and other forms of communication delivery to one or more users of the monitoring services and/or owners of the animals registered to a user profile. Embodiments of the communication module 215 may transmit alerts and notifications to user client systems 221, in response to the identification of a behavior or safety event by the knowledge base 217 and/or machine learning engine 211 as a function of analyzing a data feed being transmitted from one or more monitoring zones. Embodiments of alerts and notifications sent from the communication module 215 may be displayed by the user interface 223 of the user client system 221 and may include information describing the registered animals involved with the behavior or safety event, a description of the event taking place, the date and time of the event and any responsive measure taken by the monitoring system to protect or stop the animals from continuing to act in a manner that has caused the behavior or safety event to occur. For example, one or more pre-determined actions executed by the monitoring system, such as the issuance of verbal commands over a speaker system within the monitoring zone, remotely closing or adjusting doors, barriers or locking mechanisms, activating invisible fencing collars, etc.

In some embodiments, the communication module 215 may transmit a real-time audio and/or video feed to the user client system 221, allowing the user to observe the occurrence of the behavior or safety event in real time. In some instances, the communication module 215 may request the user receiving the audio and/or video feed to confirm whether the details of the notifications or alerts are accurate. For example, by confirming that the correct animal is identified and that the behavior or safety event being reported is occurring. For instance, cattle attempting to leave a fenced in area is reported as a behavior or safety event, along with the identifiers of the registered cattle based on cattle tags or visual images of the cattle detected by the video surveillance system 225. A notification can be pushed by the communication module 215 to the user interface 223, wherein the user can view the video feed, confirm the correct cattle were identified in the notification and further confirm whether or not the cattle are in fact attempting to leave the fenced area of the monitoring zone as reported by the communication module 215.

In some embodiments, upon user confirmation of the behavior or safety event being reported by the communication module 215, the user may respond to the notifications or alerts by selecting one or more corrective actions to employ by the monitoring service to deter undesired or unsafe behaviors by the animals from continuing. For example, using the cattle example above, initiating measures to deter the cattle from continuing to leave the fenced area and return to the monitoring zone. In other embodiments, users receiving the notifications or alerts may receive a list of recommended actions proposed by the communication module 215 for deterring, reducing, minimizing or eliminating potential sources of harm to the animals engaged in a behavior or safety event. Users may input into the user interface 223 one or more selected pre-determined actions proposed by the communication module 215. In some embodiments, the types of pre-determined actions may be automatically implemented by the monitoring module 203 in response to confirmation of the behavior and safety event by the user. For example, confirmation by a user that a registered animal is attempting to escape, a registered animal is breaking into an location that may be dangerous to the registered animal, an unauthorized human or animal has entered the monitoring zone, or safety of the monitoring zone has been compromised (i.e. fire, fallen trees, flooding, etc.). A second notification or alert may be transmitted to the user client system 221 further updating the user regarding the actions applied to the monitoring zone and the results thereof. For example, a user may receive an alert describing a behavior or safety event indicating that cattle have escaped from the fence forming the boundary of the monitoring zone. Upon confirmation by the user that the cattle have indeed escaped, a corrective action, such as activating security collars worn by the cattle which may broadcast the location of the cattle and/or initiate disciplinary measures to incentivize the cattle to return to the fenced area of the monitoring zone. Upon automatically implementing said security measures, a second notification may be transmitted by the communication module 215 indicating the safe return of the cattle to the monitoring zone. In another example, a user may receive an alert describing a safety event wherein the monitoring zone itself has become unsafe for the animals, for example due to hazardous environments or intrusion. Upon confirmation by the user of the hazard or intrusion, the system may respond accordingly, automatically, by blaring an alarm or contacting local authorities (in the case of an intrusion by an animal or human), whereas when the event is environmental and the monitoring zone itself may be considered unsafe, doors or barricades may be released, invisible fencing may be deactivated so the animals can leave the hazardous area into a larger outdoor pen, fire suppression or sprinklers may be activated, etc. In some instances, a data feed may be further transmitted to the user client system 221 displaying video evidence that the behavior or safety event has been safely managed and that the registered animals are no longer in danger of harm.

In some embodiments, the communication module 215 may communicate within the notifications and alerts one or more facts describing the results of the behavior or safety event. Such recitation of facts as determined by the machine learning engine 211 and/or knowledge base 217 can be reported to the user in order to allow the user to pursue or select one or more remedies, actions or treatments that may minimize, eliminate or alleviate potential harm to the registered animals engaged in the behavior or safety event. For example, knowledge base 217 may analyze a real-time video feed of an event provided by video surveillance system 225 and within the video feed a registered animal may be depicted opening a container comprising medication and consuming a quantity of medication. The knowledge base 217 in conjunction with machine learning engine 211 may be able to parse the video data of the real-time data feed and through the use of image recognition and/or historical data, the monitoring module 203 can identify the registered animal(s) who broke into the container, the type of medication consumed, and an estimated quantity of medication that was consumed. The notification or alerts provided to the user client system 221 by the communication module 215 may include the relevant information about this particular recorded event and include within the notification an estimate describing the types and amounts of medications consumed. Moreover, based on the records of the knowledge base, one or more recommendations for providing care to the animal can further be provided to the user via the notification or alert, including best practices for counteracting the consumed medication, symptoms to look for in the animal and advice regarding when to seek additional medical assistance. Similarly, under the circumstances wherein the behavior or safety event includes a danger external to the monitoring zone entering the monitoring zone, such as an attack by a non-registered animal, parsing the real-time data feed may indicate how the external threat entered the monitoring zone, and the types of treatment that may be necessary to treat the affected animal. For example, identifying a particular type anti-venom if the intruder is identified as a poisonous animal or providing safe steps and protocols for treating the registered animal if the intruder is known to be a potentially rabid animal.

Embodiments of the monitoring module 203 may comprise a corrective action module 209. The corrective action module may perform the tasks or functions of the monitoring module 203 directed toward implementing one or more responsive measures, such as a corrective actions or pre-determined actions within a monitoring zone in response to the occurrence of a behavior or safety event. For example, the corrective action module 209 may activate one or more IoT devices 235 positioned within a monitoring zone to alter the environment of the monitoring zone and/or communicate with the registered animals. For instance, one or more predetermined actions implemented by the corrective action module 209 may include activating two-way communication with the monitoring zone, allowing for a user or owner to actively speak to the animals, for example, in order to issue verbal commands via one or more speakers or audio systems. In some instances, the predetermined action performed by the corrective action module 209 may include one or more automation actions, which may be implemented via one or more IoT devices 235. Examples of automation actions may include activating or flashing lights, playing pre-recorded messages, activating an alarm system, horn or siren, opening or closing doors, locking or closing containers or storage devices, moving or shifting barriers, fencing and/or fence doors, activating or deactivating invisible fencing, initiating disciplinary devices such as collars, activating or deactivating a feeding device, and/or remotely changing a configuration of any other type of IoT device 235 in response the behavior or safety event.

Referring to the drawings, FIG. 2B depicts an alternative embodiment, comprising a containerized computing environment 250, wherein host system 201 may containerize one or more monitoring modules 203a-203n into multiple separate containerized environments of a container cluster (depicted as containers 270a-270n), being accessed by monitoring environments 251a-251n, each comprising at least one of a corresponding client system 221a-221n, video surveillance system 225a-225n, audio surveillance system 227a-227n, sensor device 229a-229n, identification devices 231a-231n and IoT devices 235a-235n. Embodiments of the host system 201 may manage monitoring operations of one or more monitoring zones via a host operating system 255 for the containerized applications being deployed and hosted by the host system 201 in a manner consistent with this disclosure. Embodiments of the containers 270 comprise an application image of the monitoring module 203a-203n, and the software dependencies 269a-269n, within the container's 270 operating environment. The host system 201 may run a multi-user operating system (i.e. the host operating system 255) and provide computing resources via the host system hardware 257 to the one or more containers 270a-270n (referred to generally as containers 270) comprising the containerized computer environment 250 for executing and performing functions of monitoring module 203.

Embodiments of computing environment 250 may be organized into a plurality of data centers that may span multiple networks, domains, and/or geolocations. The data centers may reside at physical locations in some embodiments, while in other embodiments, the data centers may comprise a plurality of host systems 201 distributed across a cloud network and/or a combination of physically localized and distributed host systems 201. Data centers may include one or more host system 201, providing host system hardware 257, a host operating system 255 and/or containerization software 253 such as, but not limited to, the open-source Docker and/or OpenShift software, to execute and run the containerized application images of the monitoring module 203a-203n encapsulated within the environment of the containers 270a-270n, as shown in FIG. 2B. Although the exemplary embodiment depicted in FIG. 2B includes four containers 270, the embodiment of FIG. 2B is merely illustrative of the concept that a plurality of containers 270 can be hosted and managed by a host system 201. The embodiment of FIG. 2B should in no way be considered to imply that the host systems 201 is limited to hosting only four containers 270. The number of containers 270 hosted and managed by a host system 201 may vary depending on the amount of computing resources available, based on the host system hardware 257 and the amount of computing resources required by application images being executed within the containers 270 by the containerization software 253.

Embodiments of the containerization software 253 may operate as a software platform for developing, delivering, and running containerized programs and applications, as well as allowing for the deployment of code quickly within the computing environment of the containers 270. Embodiments of containers 270 can be transferred between host systems 201 as well as between different data centers that may be operating in different geolocations, allowing for the containers 270 to run on any host system 201 running containerization software 253. The containerization software 253 enables the host system 201 to separate the containerized applications and programs from the host system hardware 257 and other infrastructure of the host system 201 and manage monitoring operations of multiple monitoring environments 251 using containerized applications being run and executed on the host system 201 via the host system's operating system 255.

The containerization software 253 provides host system 201 with the ability to package and run application images such as monitoring module 203 within the isolated environment of the container 270. Isolation and security provided by individual containers 270 may allow the host system 201 to run multiple instances of the monitoring module 203 while simultaneously managing multiple monitoring environments 251a-251n for all of the application images on a single host system 201. A container 270 may be lightweight due to the elimination of any need for a hypervisor, typically used by virtual machines. Rather, the containers 270 can run directly within the kernel of the host operating system 255. However, embodiments of the application images may benefit from combining virtualization of virtual machines with containerization. For example, the host system 201 may be a virtual machine running containerization software 253.

Embodiments of the containerization software 253 may comprise a containerization engine (not shown). The containerization engine may be a client-server application which may comprise a server program running a daemon process, a REST API specifying one or more interfaces that the applications and/or other programs may use to talk to the daemon process and provide instructions to the application image, as well as a command-line interface (CLI) client for inputting instructions. In one embodiment, the client system 221 may input commands using a CLI to communicate with the containerization software 253 of the host system 201. In the exemplary embodiment depicted in FIG. 2B, commands provided by the client system 221 to the host system 201 may be input via the user interface 223 loaded into the memory 105 or persistent storage 106 of the client system 221 interfacing with the host system 201.

Embodiments of the CLI may use the REST API of the containerization engine to control or interact with the daemon through automated scripting or via direct CLI commands. In response to the instructions received from the CLI, via the REST API, the daemon may create and manage the containerization software 253, including one or more software images residing within the containers 270, the containers 270 themselves, networks, data volumes, plugins, etc. An image may be a read-only template with instructions for creating a container 270 and may be customizable. Containers 270 may be a runnable instance of the software image. Containers 270 can be created, started, stopped, moved or deleted using a containerization software 253 API or via the CLI. Containers 270 can be connected to one or more networks 220, can be attached to a storage device and/or create a new image based on the current state of a container 270.

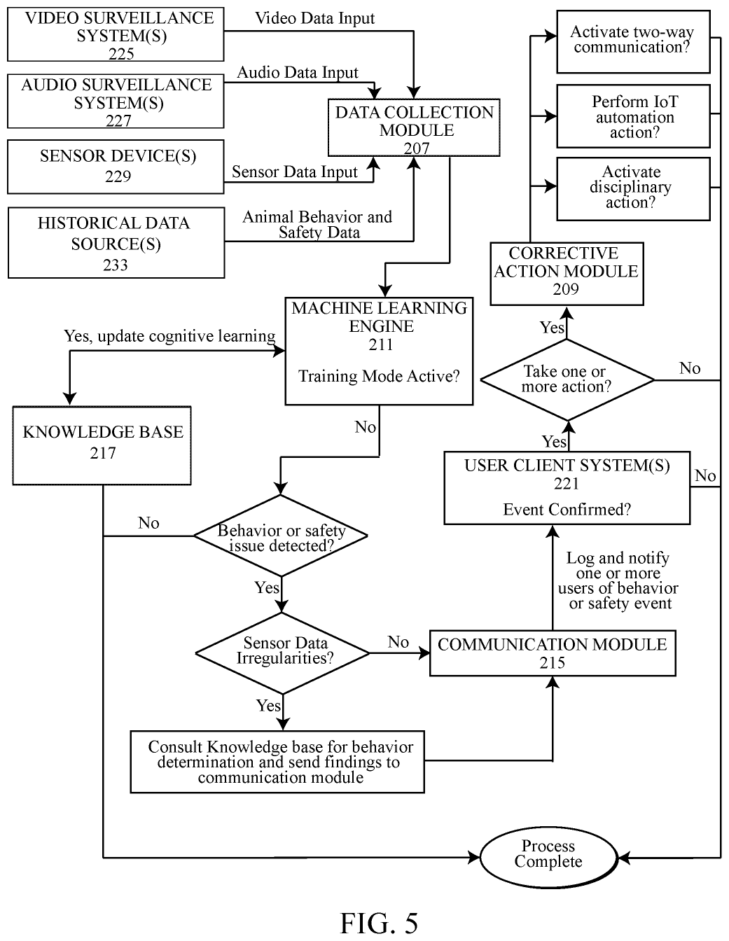

Referring to the drawings, FIG. 5 depicts a flow chart describing an exemplary embodiment for monitoring a monitoring zone using the monitoring module 203 described above, training the monitoring module 203 to identify registered animals and behavior or safety events and selecting one or more responses to the occurrence of a behavior or safety event captured by the monitoring module 203. As described above, a monitoring zone can be identified by a user of the monitoring module 203 and installed with one or more video surveillance systems 225, audio surveillance systems 227, and sensor devices 229. Each of the data sources installed within the monitoring zone or associated within a registered animal of the monitoring zone may transmit a data feed into the data collection module 207. As shown in FIG. 5, the video surveillance system 225 may input video data; the audio surveillance system 227 may input audio data; and the sensor device 229 may input sensor data. Additionally, in some embodiments, one or more historical data sources 233 may further input historical data, including data depicting historical animal behavior and safety data, such as past behaviors and actions of registered animals as well as similar animals to those registered with the monitoring zone.

The data collection module 207 receiving the data feed from surveillance systems 225, 227, sensor devices 229 and/or historical data sources 233 may share the collected data of the data feed with the machine learning engine 211. The behavior of the machine learning engine 211 may vary depending on whether training mode of the machine learning engine 211 is active or not. As shown, while the machine learning engine 211 is training to learn or improve the identification of registered animals and/or behavior and safety events from the inputted data, the machine learning engine 211 may use one or more machine learning techniques, deep learning, etc. to improve one or more models and/or update the knowledge base 217 based on the analysis of the inputted data from the data collection module 207. Likewise, during non-training analysis of the inputted data from the data collection module 207, the machine learning engine 211 may use one or more machine learning models 213 and/or the knowledge base 217 to identifying one or more registered animals of the data feed (i.e. by audio, video, etc.) and determine whether or not a behavior or safety event has occurred. In some embodiments, where the behavior or safety event is detected within the data extracted from the data feed, the machine learning engine 211 may further determine whether or not the sensor data from one or more sensor devices 229 indicates irregularities. Where the sensor data does not indicate an irregularity, but a behavior or safety event is detected, the identification of the registered animals and the identified behavior or safety event may be sent to the communication module 215 which may logs the occurrence of the event, along with the relevant details describing the identified event. Similarly, where sensor data irregularities have been identified alongside the identification of a behavior or safety event, the knowledge base 217 may be further consulted for a behavior determination, historical responses to such a situation and provide one or more recommendations for responding to the sensor data irregularities. Similar to the previously discussed measures, the communication module 215 may log the details of not only the behavior or safety event, but additionally the occurrence of the sensor data irregularities and the determinations of the cause of the sensor irregularities by the knowledge base 217.

As shown by the embodiment of the flow chart in FIG. 5, upon logging the information of the behavior or safety event and/or the determinations by the knowledge base 217, the communication module 215 may alert a user of the potential behavior or safety event, by transmitting a notification or alert to the user client system 221. A user receiving the notification or alert via the user client system 221, may review the data feed, evidence of the behavior or safety event provided by the communication module 215, including audio, video, image, sensor data and other evidence, and confirm whether or not the monitoring module 203 has correctly predicted the occurrence of the behavior or safety event, and/or identified the correct registered animal(s) associated with such an identified event. If the identification the behavior or safety event is incorrect, the user can deny that such an event has occurred, and/or that the correct animal has been identified. Feedback from the user can be used to help improve the monitoring service's ability to make correct predictions. Likewise, where correct identifications of the registered animal(s) and the occurrence of the behavior or safety event are correct, user's can elect to take one or more actions to alleviate or deter the animals from continuing with the ongoing behavior causing the identified event. Upon selection of a pre-determined or corrective action, the corrective action module 209 may implement the selected action. For example, by engaging one IoT devices 235 positioned within the monitoring zone to engage in an automation action, activate a disciplinary action and/or activate two-way communication with the registered animal(s) and allow the user to provide verbal commands or sounds that may cause the registered animal(s) to cease the behaviors causing the identified events.

Method for Monitoring Animal Behavior and Safety

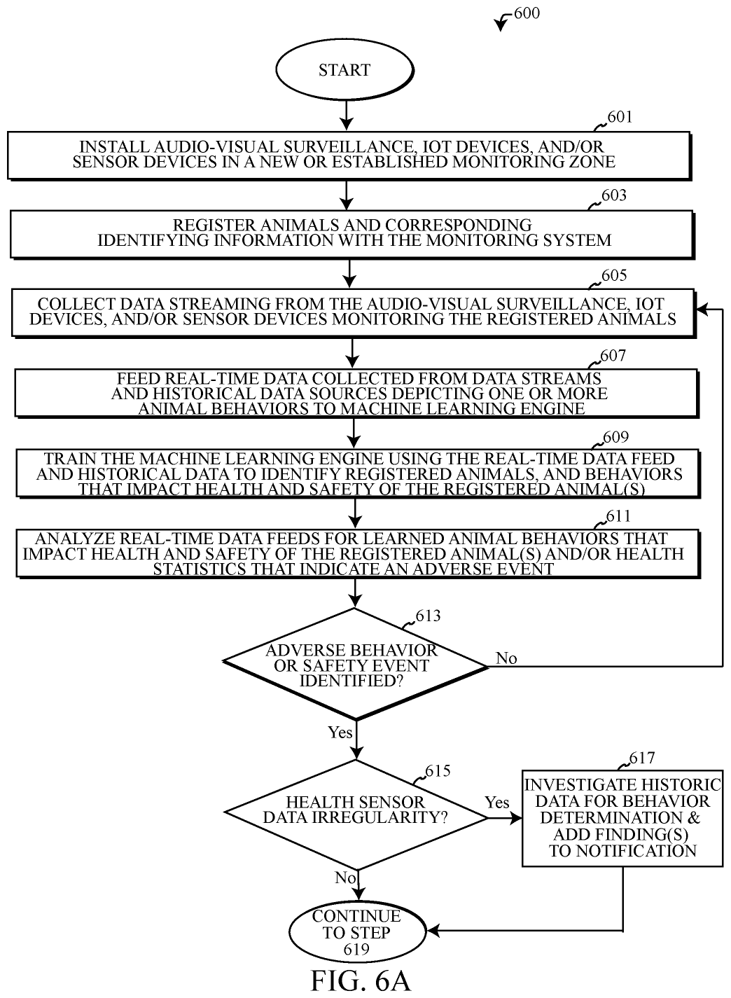

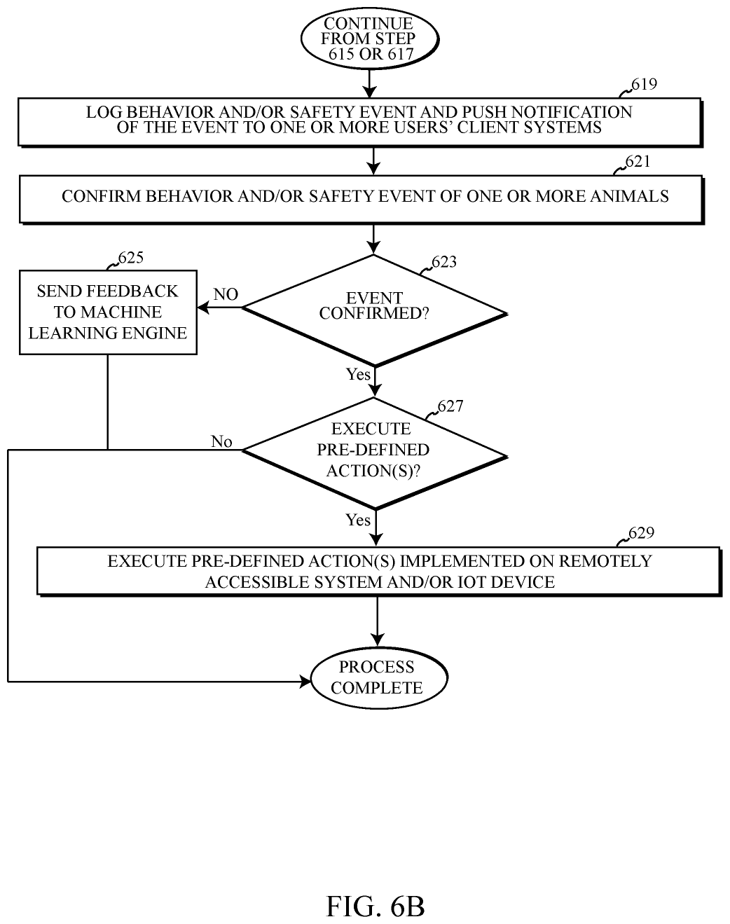

The drawing of FIGS. 6A-6B represents an embodiment of an algorithm 600, performing a computer-implemented method for monitoring the behavior and safety of animals. The algorithm 600, as shown and described by FIGS. 6A-6B, may use one or more computer systems, defined generically by data processing system 100 of FIG. 1, and more specifically by the embodiments of specialized data processing systems of computing environments 200, 250, 300, depicted in FIGS. 2A-5 and as described herein. A person skilled in the art should recognize that the steps of the algorithm 600 described in FIGS. 6A-6B may be performed in a different order than presented. The algorithm 600 may not necessarily require all the steps described herein to be performed. Rather, some embodiments of algorithm 600 may alter the methods by performing a subset of steps using one or more of the steps discussed below.

Embodiments of the algorithm 600 may begin at step 601. In step 601, a monitoring zone may be established and outfitted with audio-visual surveillance equipment, including one or more surveillance systems 225, 227, as well as IoT devices 235, identification devices 231 and sensor devices 229. Surveillance systems 225, 227, sensor devices 229 and IoT devices 235 may placed in fixed or moving positions throughout the monitoring zone or may be affixed to one or more animals that will be registered to the monitoring zone. For example, collars or other devices worn by the animals may be equipped with surveillance systems 225, 227, and/or sensor devices 229. In some embodiments, identification devices 231 may also be attached or affixed to the animals residing within the monitoring zone being established. For instance, cattle tags or chips may be attached to the animals or embedded which may visually or electronically identify the animal to an observer of the monitoring zone.

In step 603, a user can configure the monitoring zone by registering one or more animals with selected monitoring zones established in step 601. Users can further input corresponding information about the registered animals assigned to the one or more monitoring zones, including one or more identifying characteristic of the registered animals, identification devices 231 associated with the registered animal and associate one or more sensor devices affixed or connected to the registered animal. In some instances, additional data may also be provided describing the registered animal, including one or more images or videos of the animal, and/or an identifying audio sound print of the animal.

In step 603, the data collection module 207 may collect data streaming from one or more audio surveillance system 227, video surveillance system 225, sensor device 229, identification device 231 and/or IoT device 235. The streaming data feed may be collecting and sending data from the monitoring zone in real-time to the monitoring module 203 for analysis in some embodiments. In other embodiments, the streaming data may be saved and stored for further analysis and processing at a later point in time. In step 607, the data streaming from the devices, sensors and systems within the monitoring zone, along within historical data retrieved from one or more data sources 233 depicting one or more animal behaviors or actions by an animal may be sent to the machine learning engine 211 for analysis, and/or for training one or more machine learning models 213.

In step 609, the machine learning engine 211 and/or knowledge base 217 may be trained using the data feed collected and shared by the data collection module 207 and the historical data retrieved from one or more historical data sources 233. The machine learning engine 211 may analyze and process the collected data and/or historical data in order to generate and/or update one or more machine learning models 213 which may predict the occurrence of one or more behaviors that impact the health and safety of the registered animals (i.e. a behavior or safety event). Moreover, the machine learning engine 211 may also analyze the collected data to generate or update machine learning models 213 for properly identifying registered animals based on the collected data (i.e. based on images, video, audio, sensor data, identification device data, etc.). Moreover, in step 611, using the trained machine learning models 213 and/or the knowledge of the knowledge base 217, the collected data feeds are analyzed in real-time for learned animal behaviors that impact the health and safety of the registered animals. As a result, a behavior or safety event can be identified, which may have previously occurred, or is currently occurring in real-time. Moreover in some embodiments of step 611, the analysis of the collected data from the data collection module 207 may further identify the presence of sensor data indicating health parameters or statistics collected by one or more sensor device 229, indicating an adverse health-related event or emergency that may be ongoing or previously occurred to a registered animal.

In step 613, a determination is made, based on the collection and analysis of the data from the data collection module 207 and/or the real-time data feeds, whether or not an adverse behavior or safety event has been identified using the machine learning models 213 and/or the collective knowledge of the knowledge base 217. If, in step 613, a behavior or safety event has not been identified, the algorithm 600 may proceed back to step 605 and continue collecting data streaming from the surveillance systems 225, 227, sensor devices 229, IoT devices 235 and other systems or devices positioned within the monitoring zone. Conversely, if the determination in step 613 indicates the occurrence of a behavior or safety event, the algorithm 600 may proceed to step 615. In step 615, a further determination may be made whether or not a sensor device 229, such as a health sensor, has collected sensor data that may indicate a health-related irregularity within one or more registered animals. If such an irregularity is not identified within the collected sensor data, the algorithm may proceed directly to step 619. However, if an irregularity is identified within the sensor data as a result of analysis by either the knowledge base 217 and/or the machine learning engine 211, the knowledge base 217 may be queried in step 617 to predict and determine the cause of the sensor data irregularities associated with the registered animal. For example, by determining the cause the sensor data irregularities, such as ingestion of a substance, over-consumption of a substance, exposure to an undesired or harmful environmental factor, injury, etc. Upon identifying or predicting the underlying cause of the irregularity in the sensor data, details of the finding may be processed for transmission as a notification or alert, which may be prepared by the communication module 215.

In step 619, the communication module 215 may log the occurrence of the identified behavior or safety event and generate a notification, alert, email, or other type of communication detailing the behavior or safety event. The notification, alert or communication describing the details of the event may be transmitted to one or more users and may be displayed by the user interface 223 of the user client systems 221 receiving the communication from the communication module 215. In step 621, a user viewing the communication received from the communication module 215 may review the details and any particular evidence that may be transmitted, including any accompanying images, video, audio, sensor data, health determinations or details in step 617, identification device data and any other data that may help the user confirm the occurrence of the behavior or safety event, the identities of the animals involved and any potential treatments or actions that may be best suited as a response. Based on the details and evidence provided in the communication reviewed by the user, in step 623, a determination is made whether or not the user has confirmed the behavior or safety event's occurrence. If upon review by a user, a behavior or safety event has been determined not to have occurred, the algorithm 600 may proceed to step 625, wherein the user can send feedback to the machine learning engine 211 and/or knowledge base 217 to further improve the algorithm's 600 ability to properly predict a behavior or safety event.

Conversely, if in step 623, the user receiving the communication from the communication module 215 and supporting evidence, confirms the accuracy of the predictions by the monitoring module 203 regarding the occurrence of the behavior or safety event, as well as the registered animal(s) involved with the behavior or safety event, the algorithm 600 may proceed to step 627. In step 627, a pre-defined action may be executed by the user or the monitoring module 203. For example, the user may manually select pre-determined action from a list of predetermined actions and/or recommended actions presented by the monitoring module 203. Upon manual selection of a predetermined action or recommended action, the correction action module 209 may, in step 629, execute the selected pre-defined action. Alternatively, in other instances, upon confirmation of the behavior or safety event, the corrective action module 209 may automatically implement a best predetermined action as identified by the knowledge base and/or a most likely pre-defined to alleviate the confirmed behavior or safety event. Embodiments of the corrective action module 209 may execute the pre-defined action(s) on a remotely accessible system, such as an IoT device 235 positioned within the monitoring zone, including activating automation devices, opening remote communications between the user and the monitoring zone, or activating disciplinary measure. For example, activating an animal collar, activating invisible fencing, locking a remotely accessible door or container, remotely moving a motorized door or barrier capable of being moved from a first position to a second position, flashing lights, blaring a siren, playing pre-recorded messages over speakers, and/or activating communication systems to allow a user to vocally provide commands via the client system 221 which can be heard by the animals within the monitoring zone.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
registering, by a processor an animal with a monitoring system, said monitoring system comprising a surveillance system observing a monitoring zone in real-time;
training, by the processor, the monitoring system to recognize the animal registered with the monitoring system and further training the monitoring system to predictively identify adverse behaviors or safety events using historical data of the animal registered with the monitoring system or historical recordings of similar animals to the animal registered with the monitoring system;
analyzing, by the processor, a real-time data feed comprising audio or video data collected by the monitoring system;
identifying, by the processor, based on analysis of the real-time data feed, an occurrence of an adverse behavior or safety event happening in real-time; and
remotely triggering, by the processor, a pre-defined action within the monitoring zone that is experienced by the animal registered with the monitoring system and is anticipated by the monitoring system to alleviate or mitigate the adverse behavior or safety event happening in real-time.

2. The computer-implemented method of claim 1, wherein the monitoring system further comprises a sensor device measuring health parameters of the animal and transmitting the health parameters from the sensor device in real-time as part of the real-time data feed.

3. The computer-implemented method of claim 2, wherein identification of the adverse behavior or safety event happening in real-time is identified as a function of the health parameters collected by the sensor device in real-time.

4. The computer-implemented of claim 1, wherein training the monitoring system to recognize the animal registered with the monitoring system includes training based on audio and visual identifiers selected from the group consisting of tags attached to the animal, a sound print of the animal, and image recognition of the animal as a function of registered characteristics or historical data of the animal provided to the monitoring system.

5. The computer-implemented method of claim 1, further comprising:
transmitting, by the processor, a notification to a user describing the adverse behavior or safety event and the animal affected by said adverse behavior or safety event;
transmitting, by the processor, the real-time data feed, or a portion thereof, depicting the adverse behavior or safety event to the user;
requesting, by the processor, confirmation from the user of the adverse behavior or safety event; and
recommending, by the processor, one or more pre-defined actions to remotely trigger, identified by the monitoring system to alleviate the adverse behavior or safety event.

6. The computer-implemented method of claim 1, wherein the pre-defined action is performed by an IoT device positioned within the monitoring zone and connected to the monitoring system.

7. The computer-implemented method of claim 1, wherein the pre-defined action is selected from the group consisting of activating two-way communication with the animal, performing an automation action on an device positioned within the monitoring zone that alters the monitoring zone, and remotely activating a correction device connected to the animal.

8. A computer system comprising:
a processor;
a monitoring system placed in communication with the processor, said monitoring system comprising a surveillance system observing a monitoring zone in real-time; and
a computer-readable storage media coupled to the processor, wherein the computer-readable storage media contains program instructions executing a computer-implemented method comprising:
registering, by the processor, an animal with the monitoring system;
training, by the processor, the monitoring system to recognize the animal registered with the monitoring system and further training the monitoring system to predictively identify adverse behaviors or safety events using historical data of the animal registered with the monitoring system or historical recordings of similar animals to the animal registered with the monitoring system;
analyzing, by the processor, a real-time data feed comprising audio or video data collected by the monitoring system;
identifying, by the processor, based on analysis of the real-time data feed, an occurrence of an adverse behavior or safety event happening in real-time; and
remotely triggering, by the processor, a pre-defined action within the monitoring zone that is experienced by the animal registered with the monitoring system and is anticipated by the monitoring system to alleviate or mitigate the adverse behavior or safety event happening in real-time.

9. The computer system of claim 8, wherein the monitoring system further comprises a sensor device measuring health parameters of the animal and transmitting the health parameters from the sensor device in real-time as part of the real-time data feed.

10. The computer system of claim 9, wherein identification of the adverse behavior or safety event happening in real-time is identified as a function of the health parameters collected by the sensor device in real-time.

11. The computer system of claim 8, wherein training the monitoring system to recognize the animal registered with the monitoring system includes training based on audio and visual identifiers selected from the group consisting of tags attached to the animal, a sound print of the animal, and image recognition of the animal as a function of registered characteristics or historical data of the animal provided to the monitoring system.

12. The computer system of claim 8, further comprising:
transmitting, by the processor, a notification to a user describing the adverse behavior or safety event and the animal affected by said adverse behavior or safety event;
transmitting, by the processor, the real-time data feed, or a portion thereof, depicting the adverse behavior or safety event to the user;
requesting, by the processor, confirmation from the user of the adverse behavior or safety event; and
recommending, by the processor, one or more pre-defined actions to remotely trigger, identified by the monitoring system to alleviate the adverse behavior or safety event.

13. The computer system of claim 8, wherein the pre-defined action is performed by an IoT device positioned within the monitoring zone and connected to the monitoring system.

14. The computer system of claim 8, wherein the pre-defined action is selected from the group consisting of activating two-way communication with the animal, performing an automation action on an device positioned within the monitoring zone that alters the monitoring zone, and remotely activating a correction device connected to the animal.

15. A computer program product comprising:
one or more computer-readable storage media having computer-readable program instructions stored on the one or more computer-readable storage media said program instructions executes a computer-implemented method comprising:
registering, by a processor an animal with a monitoring system, said monitoring system comprising a surveillance system observing a monitoring zone in real-time;
training, by the processor, the monitoring system to recognize the animal registered with the monitoring system and further training the monitoring system to predictively identify adverse behaviors or safety events using historical data of the animal registered with the monitoring system or historical recordings of similar animals to the animal registered with the monitoring system;
analyzing, by the processor, a real-time data feed comprising audio or video data collected by the monitoring system;
identifying, by the processor, based on analysis of the real-time data feed, an occurrence of an adverse behavior or safety event happening in real-time; and
remotely triggering, by the processor, a pre-defined action within the monitoring zone that is experienced by the animal registered with the monitoring system and is anticipated by the monitoring system to alleviate or mitigate the adverse behavior or safety event happening in real-time.

16. The computer program product of claim 15, wherein the monitoring system further comprises a sensor device measuring health parameters of the animal and transmitting the health parameters from the sensor device in real-time as part of the real-time data feed.

17. The computer program product of claim 16, wherein identification of the adverse behavior or safety event happening in real-time is identified as a function of the health parameters collected by the sensor device in real-time.

18. The computer program product of claim 15, wherein training the monitoring system to recognize the animal registered with the monitoring system includes training based on audio and visual identifiers selected from the group consisting of tags attached to the animal, a sound print of the animal, and image recognition of the animal as a function of registered characteristics or historical data of the animal provided to the monitoring system.

19. The computer program product of claim 15, further comprising:
transmitting, by the processor, a notification to a user describing the adverse behavior or safety event and the animal affected by said adverse behavior or safety event;
transmitting, by the processor, the real-time data feed, or a portion thereof, depicting the adverse behavior or safety event to the user;
requesting, by the processor, confirmation from the user of the adverse behavior or safety event; and
recommending, by the processor, one or more pre-defined actions to remotely trigger, identified by the monitoring system to alleviate the adverse behavior or safety event.

20. The computer program product of claim 15, wherein the pre-defined action is selected from the group consisting of activating two-way communication with the animal, performing an automation action on an device positioned within the monitoring zone that alters the monitoring zone, and remotely activating a correction device connected to the animal.
